(19) United States
(12) Patent Application Publication
(10) Pub. No.: US 2017/0010151 A1
(43) Pub. Date: Jan. 12, 2017

(54) SYSTEM AND METHOD FOR COMPENSATING SPECTROPHOTOMETER THERMAL DRIFT WITHOUT DIRECT TEMPERATURE MEASUREMENT

(71) Applicant: DATACOLOR HOLDING AG, Luzern (CH)

(72) Inventors: Zhiling Xu, West Windsor, NJ (US); Michael H. Brill, Kingston, NJ (US)

(21) Appl. No.: 14/796,628

(22) Filed: Jul. 10, 2015

(51) Int. Cl. G01J 1/44; G01J 3/46

(52) U.S. Cl. CPC G01J 1/44; G01J 3/46; G01J 2001/444

(57) ABSTRACT

In accordance with a broad aspect of the present invention, a system and method are provided for monitoring and compensating thermal drift of the electronic elements in the sensor of a color measurement device, such as a spectrophotometer. Such a system and method involves, obtaining with a color sensor a plurality of measurements of a black trap with and without illumination across a range of temperatures and using those values to generate a correlation function that allows for the compensation of thermal drift in sample measurements.

### FIELD OF THE INVENTION

The present invention relates to a system and method for compensating thermal drift in a spectrometer without the use of temperature sensors and by correlating sensor readings with measurement conditions.

### BACKGROUND OF THE INVENTION

Instruments, such as spectrophotometers, are sensitive to temperature. For example, heat generated by the light source in the spectrophotometer will change its body temperature, and cause the measurements of the sensor to drift. In some scenarios, this change in the output of the sensor is non-negligible and causes measurement errors. Ambient temperature changes will also impact the thermal balance of the spectrophotometer or other color measurement device causing the measurement results to drift. In order to compensate for this drift, a temperature sensor is usually employed to determine the instrument temperature and compensate for the effect of the temperature on the sensor measurements. For example, Published U.S. Patent Application US2014/0063496 A1 and U.S. Pat. No. 5,739,905 A, both of which are hereby incorporated by reference as if set forth in their respective entireties herein, describe using temperature sensors to correct for the effects of thermal drift.

However, the addition of a temperature sensor results in increased system cost and complexity. Furthermore, the positioning of the temperature sensor may not be ideal to monitor the temperature impact. There can exist large temperature gradients at different locations in the spectrophotometer system, thus defeating the purpose of using a temperature sensor.

Therefore, what is needed is a simple, inexpensive system and method to compensate for the thermal drift effects on a sensor of a spectrophotometer by determining the correlation between the signal intensity and at least one other parameter associated with system temperature, but independent of a sample to be measured.

### SUMMARY OF THE INVENTION

In accordance with a broad aspect of the present invention, a system and method are provided for monitoring and compensating the effects of thermal drift on the electronic elements in the sensor of a color measurement device, such as a spectrophotometer. Such a system and method involve, obtaining with a color sensor, a plurality of measurements of an ambient light exclusion target (“black trap”) with and without illumination across a range of temperatures.

In a further feature of the present invention, the measured values are used by a processor to generate and store a mid-range value for non-illuminated measurements. In a further feature, the measured values are used by a processor to generate a correlation function or data model that provides an output value in response to an input of non-illuminated measurement value. Once the correlation function is generated, a sample is analyzed with the sample sensor. For each sample under analysis, a measurement is taken of the sample without illumination and with illumination.

The sample measurement values, correlation function, and initial value are used by the processor to compensate for thermal drift effects on the sensor by applying following formula:

I_{c}=I+f(D₀)−f(D)

in which I_{c} is the thermal drift corrected sample signal and D₀ is the selected initial value.

The thermal drift corrected sample is then passed to an output for use in further calculations related to the sample under analysis.

### BRIEF DESCRIPTION OF THE DRAWINGS

The foregoing and other features of the present invention will be more readily apparent from the following detailed description and drawings of an exemplary embodiment of the invention where:

FIG. 1 is a schematic diagram detailing various components of an embodiment of the present invention;

FIG. 2 is a block diagram of an exemplary system in accordance with an embodiment of the present invention;

FIG. 3 is a flow diagram detailing the steps of an embodiment of a method described herein;

FIG. 4 is a chart of the correlation of dark measurement values to calculated intensity values according to the present invention; and

FIG. 5 is a chart of the calibration results utilizing the method and system described relative to other systems.

### DESCRIPTION OF CERTAIN ILLUSTRATIVE EMBODIMENTS OF THE INVENTION

By way of overview and introduction, the present invention concerns a system and method to achieve accurate measurement of the light properties of objects under analysis. Specifically, the system and method of the present invention are configured to compensate for thermal shifts in color measurement devices due to temperature.

According to one embodiment of the present invention, a system is described that provides a mechanism for compensating for the effects of thermal drift on a color measurement device by determining the correlation between the signal intensity measured by a sensor and another parameter that is associated with the system temperature but that is independent to the sample under measurement. By generating the correlation based on a collection of measurements made across a temperature range, the temperature based signal intensity variation can be compensated and output for further processing.

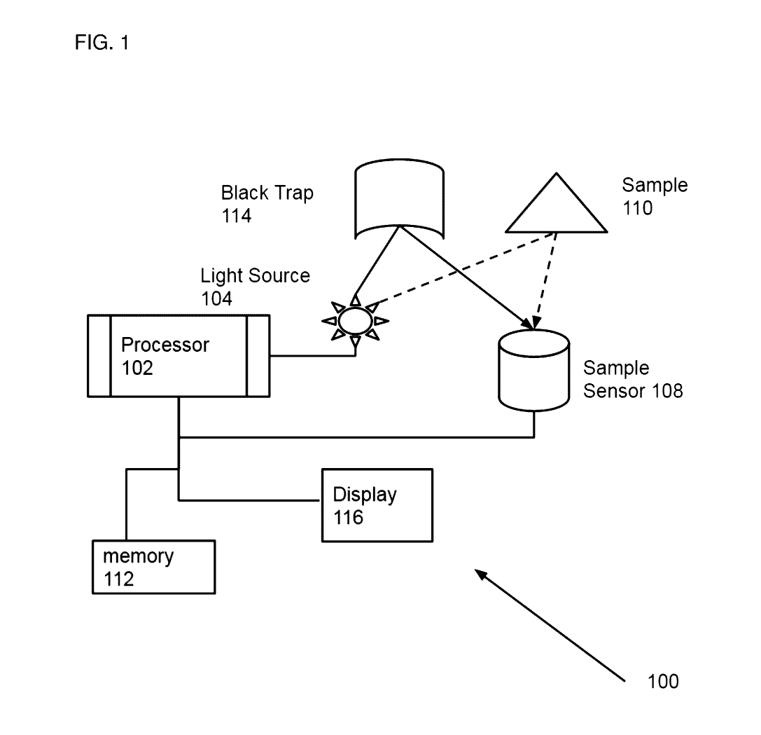

As shown in FIG. 1, the system 100 described includes a sample sensor 108. In one embodiment the sample sensor 108 is a color sensor configured to output a signal in response to light incident on a photoreceptive element incorporated into the sensor. In a particular arrangement, the sample sensor 108 is a dual 256 photo-diode array sensor coupled with holographic grating, such as one incorporated into the Datacolor 45G spectrophotometer manufactured by Datacolor Inc. of Lawrenceville, N.J. In an arrangement of the present invention, the sample sensor 108 is utilized to output a signal corresponding to the wavelength, intensity, or other parts and components of the light incident upon the sample sensor 108.

With particular reference to FIG. 1, the system 100 described also includes a selectable light source 104. The light source 104 in one embodiment is a light emitting diode (LED). In a further embodiment, the LED is a high color-rendering-index broadband LED. In a more particular configuration, the light source 104 is any light source that is controlled in response to a control signal and produces light measurable by the sample sensor 108. As used throughout, the light source 104 is configured to emit a near constant-intensity, blackbody radiation spectrum between 300 and 800 nm. In a specific instance, the light source 104 is a solid state circumferential illumination system such as the lighting system incorporated into the Datacolor 45G, or another model of spectrophotometer.

The light source 104 is used to reflect light off of, or transmit light through, a sample 110 in order to provide an analysis of color, light transmission and/or reflective properties of the sample. The system 100 further includes a black trap 114. As used herein, a black trap 114 is a calibration element or tool that assists a color sensor in making an accurate measurement of black color values without the addition of stray or ambient light. In one arrangement, the black trap is an article having an aperture leading to a dark hued interior. According to the configuration described herein, the sensor, light and other elements are configured to mate or couple to the aperture such that the light measured by the sensor 108 is obtained only from the light source 104 and not from stray or ambient light.

The processor 102 is used to receive the signals output by the sample sensor 108. In a particular arrangement, the processor 102 is configured to collect or store the output of sample sensor 108 in the memory 112 of the processor 102. These stored signals are used by the processor 102 to determine the relationship between the light intensity measured by the sample sensor 108 under illumination and non-illumination conditions. The processor 102 is configurable by code stored within the memory 112 and is able to execute instructions and process data in accordance with the disclosure provided herein.

The memory 112 in a particular arrangement is a removable storage device. In an alternative arrangement, the memory is a non-removable data storage device. In still another arrangement, the memory is a remote, network accessible storage, or cloud based storage device.

For example, the processor 102 is a general purpose microprocessor configured to execute instruction in the form of software applications. The processor 102 of the present embodiment is a hand-held analytic device, desktop, notebook or tablet computer equipped with standard connections to the display device 116. In one non-limiting embodiment, the processor 102 is configured with inputs, such as USB, FIREWIRE, eSATA, or other direct data connections. As understood herein, the functions of the processor 102 are controlled by an operating system that is compatible or operable with commercially available software packages. In a particular arrangement the processor 102 is a component of a spectrophotometer, such as the Datacolor 45G.

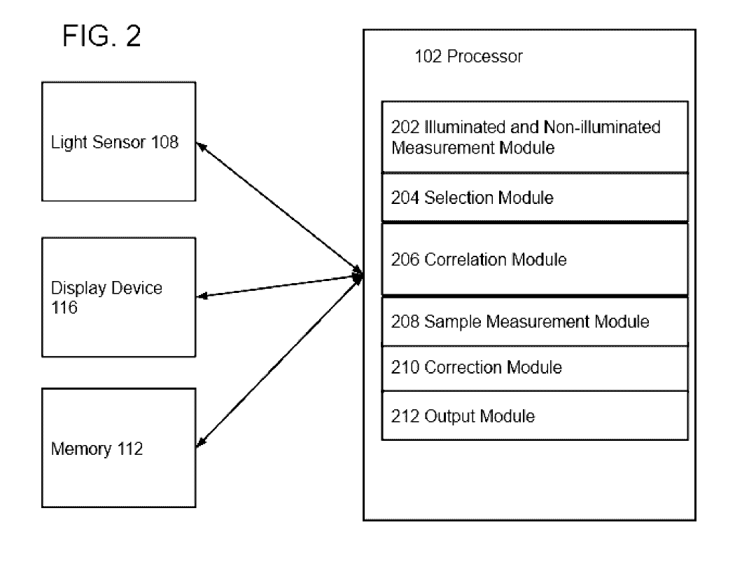

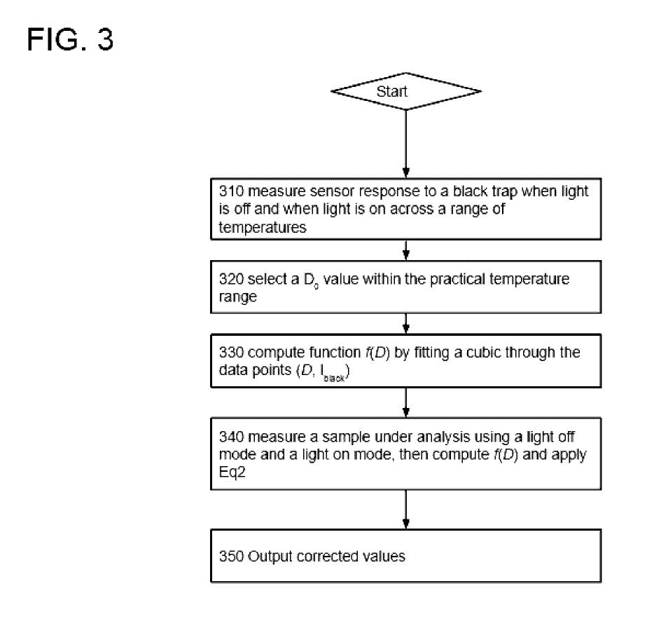

Turning to FIGS. 2 and 3, a series of steps performed by a properly configured system using one or more modules of computer-executable code can be used to implement the tasks of the processor 102. For instance, a set of software modules can cooperate with one another to configure the processor 102 so that when executed, they monitor and compensate for the thermal drift encountered by light sensor 108.

In a particular embodiment, the processor 102 is configured by an illuminated and non-illuminated measurement module 202 to obtain from the sample sensor 108 a plurality light intensity measurements of a black trap 114 with the light source 104 deactivated according to step 310 of FIG. 3. The illuminated and non-illuminated measurement module 202 is also configured to obtain from the sample sensor 108 a plurality of light measurements of the black trap 114 with the light source 104 activated as in step 310 of FIG. 3. In a particular arrangement, these measurements are obtained in a pair-wise fashion, such that a measurement of the black trap 114 with the light source deactivated is immediately followed with a measurement of the black trap 114 with the light source 104 activated or vice versa. Measurements of the black trap 114, with and without the light source 104 activated are obtained for a range of temperatures.

In one embodiment, the processor 102 is configured by the illuminated and non-illuminated measurement module 202 to automatically obtain measurement values across a defined time period. For example, a sub-module of the illuminated and non-illuminated measurement module 202 is configured to instigate a data collection routine that causes, when the sensor is coupled or affixed to a black trap, to record data measurements over time to simulate changes in temperature due to sustained use or to implement a diagnostic routine.

Utilizing the selection module 204, the processor 102 is configured to select from the non-illuminated measurement values an initial value D₀ for use in correcting the thermal drift encountered by the sensor. In accordance with step 320 of FIG. 3, the D₀ value is within the practical temperature range and corresponds to the sample sensor 108 output when the black trap 114 is measured with the light source deactivated at that temperature. In an alternative arrangement, the selection module 204 is configured to obtain a range of non-illuminated measurement values and generate the arithmetic mean of the maximum and minimum values in the range. The calculated mean is then set as D₀.

For ease of explanation, the measurements obtained with the light source 104 activated can be represented by L and the measurements obtained with the light source 104 deactivated can be represented by D. The dark-corrected intensity I is computed as:

I=L−D (Eq. 1).

Due to the influence of ambient and environmental heat on the performance of the sample sensor 108, the sensor output L, its dark value D, and its dark-compensated value I can fluctuate. The changes in temperature are associated with the changes in the ambient environment and are due to heat generated by the light source itself and other factors, such as waste heat given off by electronics and the material of the sensor enclosure. To comprise an accurate light measurement, the quantity I must therefore be further corrected so as to compensate for thermal drift.

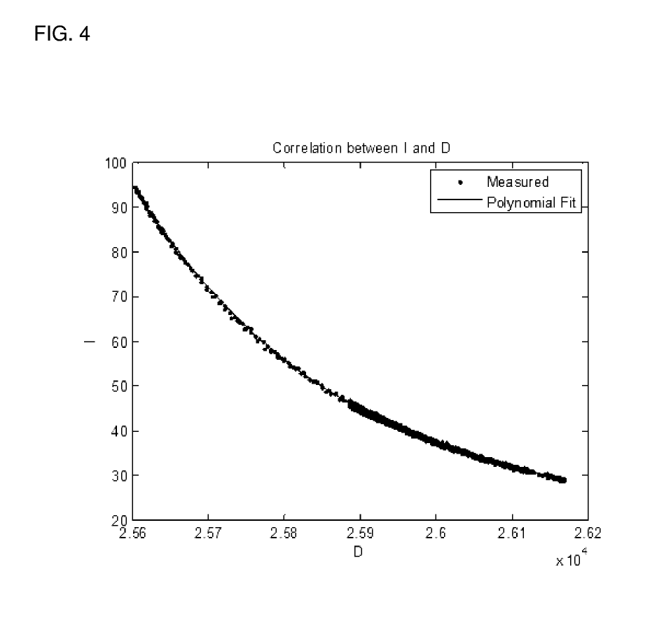

FIG. 4 provides a plot that illustrates the results of Eq. 1 across a range of temperatures. These points can be plotted or fit to a curve that represents the correlation between the non-illuminated measurement value and the sample sensor signal output when measuring an illuminated sample. Accordingly, the plurality of measurement values obtained from the dark and light measurement step 310 are used to generate, according to step 330 of FIG. 3, a functional relationship between the output value of the sample sensor and the non-illuminated measurement value such that

I_{black}=f(D).

In one arrangement, a correlation module 206 is configured by code executing in the processor to generate a best fitting polynomial (e.g. cubic) function that fits a curve to the data points measured by the illuminated and non-illuminated measurement module 202. In an alternative arrangement, the correlation module 206 is configured to conduct a regression analysis of the data values obtained from the measurements of the black trap 114 and generate a data model representing the correlation of the measured values to signal intensity. The generated correlation f(D) is stored in a memory of the processor 102 for use with subsequent measurements of objects under analysis.

Returning to FIG. 1, in order to make use of the data collected, a sample 110 is measured and the results of the measurement are corrected to obtain the thermally corrected signal output. In the illustrated arrangement of FIG. 1, the sample 110 is a reflective sample. However, transmissive samples are likewise envisioned.

With reference to FIG. 3, according to step 340 the sample 110 is measured with the light source 104 deactivated to obtain a value D. A second measurement of the sample is taken with the light source 104 activated to obtain an I value. Both measurements, illuminated and non-illuminated, are obtained by the sample measurement software module 208 in FIG. 2 and the measurements are stored in the memory of the processor.

Once these values are obtained, the measured values are corrected to take into account thermal drift of the sensor. In one particular arrangement, an algorithm is provided to compensate for the thermal drift of the sensor 108 that includes the correlation, initial measurement values and the sample measurement values. According to step 340 in FIG. 3, a software correction module 210 of FIG. 2 configures the processor 102 of FIG. 1 to correct for thermal drift in the measurements according to the following algorithm:

I_{c}=I+f(D₀)−f(D) (Eq. 2)

where I_{c} is the thermal drift corrected sample signal and D₀ is the selected initial value. Thus, for a given measurement I of a sample at a light-off value D, the correction from I to I_{c} effectively predicts the measurement that would have been obtained if the system temperature corresponded to a light-off value D₀.

The corrected signal intensity value I_{c} reflects the measurement of the sample with the effects of thermal drift on the sensor compensated. The corrected value can be output according to an output module 212 to a display 116, according to step 350. In an alternative arrangement, the compensated value is used as an input value for calculating or computing reflectance values as determined by a spectrophotometer.

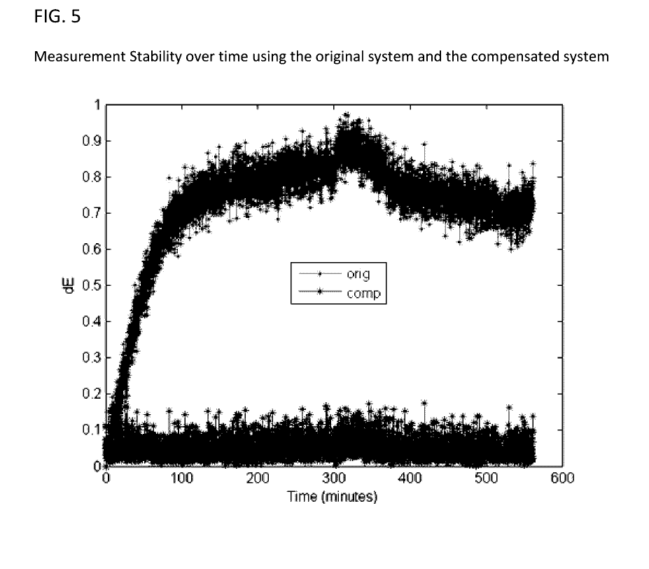

As shown in FIG. 5, the repeatability of the measurements of the compensation system according to the present invention is an improvement over the uncompensated systems that exist in the prior art. As shown, the compensated “comp” (lower trace) measurements, in accordance with the teachings of the present invention demonstrate less measurement variability over time relative to original uncompensated “orig” (upper trace) measurement values.

The present invention also incorporates a method of using the system described to carry out and achieve the function of monitoring and compensating for thermal drift of the electronic elements in the sensor of a color measurement device, such as a spectrophotometer. Such a method involves, obtaining a plurality of measurements of a black trap with and without illumination across a range of temperatures.

A further step includes selecting an initial value from one of the plurality of measured values taken without illumination. In a further step, the illuminated and non-illuminated measurement values are used to generate a correlation function that provides an output value in response to an input of a non-illumination measurement value. For each subsequent sample under analysis, a measurement step is undertaken that includes obtaining a measurement of the sample with and without illumination.

Once the sample measurement values have been recorded, the correlation function and initial value have been obtained, derived or accessed, the thermal drift effects on the sensor are corrected or compensated by applying an algorithm such as

I_{c}=I+f(D₀)−f(D) (Eq. 2)

in which I_{c} is the thermal drift corrected sample signal and D₀ is the selected initial non-illumination value. The thermal drift corrected sample data are then passed to an output for use in further calculations related to the sample under analysis.

Each of the forgoing steps can be configured as a series of discrete modules or sub-modules designed to access and control the light source device, sample sensors, memory devices and output devices. Each of these modules can comprise hardware, code executing in a processor, or both, that configures a machine, such as the computing system, to implement the functionality described herein. The functionality of these modules can be combined or further separated, as understood by persons of ordinary skill in the art, in analogous implementations of embodiments of the invention.

Various embodiments of the systems and techniques described here can be realized in digital electronic circuitry, integrated circuitry, specially designed ASICs (application specific integrated circuits), computer hardware, firmware, software, and/or combinations thereof. These various embodiments can include embodiment in one or more computer programs that are executable and/or interpretable on a programmable system including at least one programmable processor, such as processor 102, which can be special or general purpose, coupled to receive data and instructions from, and to transmit data and instructions to, a storage system, at least one input device, and at least one output device.

The processor is configured to operate software programs (also known as programs, software, software applications, software modules or code) include machine instructions for a programmable processor, and can be implemented in a high-level procedural and/or object-oriented programming language, and/or in assembly/machine language. As used herein, the terms machine-readable storage medium and computer-readable storage medium refer to any non-transitory computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term machine-readable signal refers to any signal used to provide machine instructions and/or data to a programmable processor. A non-transitory machine-readable storage medium does not include a transitory machine-readable signal.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse, touchscreen or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an embodiment of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

It should be understood that various combinations, alternatives and modifications of the present invention could be devised by those skilled in the art. The present invention is intended to embrace all such alternatives, modifications and variances that fall within the scope of the appended claims.

While the invention has been particularly shown and described with reference to a preferred embodiment thereof, it will be understood by those skilled in the art that various changes in form and details may be made therein without departing from the spirit and scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

Particular embodiments of the subject matter of the present invention have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above-description of embodiments of the present invention are not intended to be exhaustive or to limit the systems and methods described to the precise form disclosed. While specific embodiments of, and examples for, the apparatus are described herein for illustrative purposes, various equivalent modifications are possible within the scope of other articles and methods, as those skilled in the relevant art will recognize. The teachings of articles and methods provided herein can be applied to other devices and arrangements, not only for the apparatus and methods described above.

The elements and acts of the various embodiments described above can be combined to provide further embodiments. These and other changes can be made to the system and methods in light of the above detailed description.

What is claimed is:

1. A method for compensating the thermal drift in a spectrophotometer configured to output a signal in response to light incident upon an integrated sensor, and configured with a selectable light source, the method comprising;
obtaining, for a range of temperatures, a plurality of non-illuminated measurement values by measuring a black trap with the light source deactivated and a plurality of illuminated measurement values by measuring the black trap illuminated by the light source and recording the plurality of non-illuminated and illuminated measurements,
selecting an initial non-illuminated measurement value D₀ from the plurality of non-illuminated measurement values;
generating from the measured range of values a data model f configured to correlate the output signal of the sensor with a non-illuminated measurement value when measuring a black trap;
obtaining a sample measurement value D with the light source deactivated and a sample measurement value I with the light source activated;
generating a corrected sample measurement according to a compensation algorithm that incorporates D₀, D, I and f; and
displaying a corrected sample value based on the corrected sample measurement signal.

2. The method of claim 1, wherein the compensation algorithm is
I_{c}=I+f(D₀)−f(D),
where I_{c} is the corrected sample signal.

3. The method of claim 1, wherein the generating step includes performing regression analysis on the illuminated measurement values and the non-illuminated measurement values and obtaining a best-fitting function.

4. The method of claim 1, wherein the data model is formed by performing a regression analysis on the non-illuminated and illuminated measurement values across a range of temperatures.

5. The method of claim 1, wherein the light source is a LED.

6. The method of claim 1, where the sample sensor is a component of a spectrophotometer.

7. The method of claim 1, wherein the selection step further comprises determining the range of non-illuminated measurement values and determining a mid-range value for D₀.

8. A system for compensating thermal drift effects on a spectrophotometer sensor, the system comprising:
a. a spectrophotometer having a processor, a memory, a light source, a sample sensor configured to output a sample signal related to a measurement of a sample,
b. the processor of the spectrophotometer configured by code executing therein to implement the steps of:
i. obtaining, for a range of temperatures, a plurality of non-illuminated measurement values by measuring a black trap with the light source deactivated and a plurality of illuminated measurement values by measuring the black trap illuminated by the light source and storing the plurality of non-illuminated and illuminated measurements within the memory of the processor,
ii. selecting, with a selection module, an initial dark value Dₒ from the plurality of non-illuminated values;
iii. generating from the measured range of values a data model f configured to correlate the output signal of the sensor with a non-illuminated measurement value;
iv. obtaining a sample measurement value D with the light source deactivated and a sample measurement value I with the light source activated;
v. generating a corrected sample measurement according to:
I_{c}=I+f(D₀)−f(D),
where I_{c} is the corrected sample signal;
vi. outputting the corrected sample measurement.

9. The system of claim 8, wherein the data model is formed by performing a linear regression analysis on the non-illuminated and illuminated measurement values across a range of temperatures.

10. The system of claim 8, wherein the data model is formed by computing a best-fitting function through the non-illuminated and illuminated measurement values.

11. The system of claim 8, where the sample sensor is a component of a spectrophotometer.

12. The system of claim 8, wherein the selection step further comprises determining the range of non-illuminated measurement values and determining a mid-range value for D₀.

13. The system of claim 8, wherein the light source is a LED.
